(19) United States
(12) Patent Application Publication
(10) Pub. No.: US 2006/0145559 A1
(43) Pub. Date: Jul. 6, 2006

(54) Electronically commutated single-phase motor

(76) Inventors: Ljubomir Kopac, PORDENONE (IT); Massimo Furlan, Conegliano (IT); Paolo Alberghetti, Sacile (IT)

Correspondence Address: WENDEROTH, LIND & PONACK, L.L.P., 2033 K STREET N. W., SUITE 800, WASHINGTON, DC, 20006-1021, US

(21) Appl. No.: 10/545,134

(22) PCT Filed: Dec. 22, 2003
(86) PCT No.: PCT/EP03/14736

§ 371 Date: Aug. 10, 2005

(30) Foreign Application Priority Data
Feb. 12, 2003 (IT) PN2003A000009

(51) Int. Cl. H02K 11/00; H02K 23/02; H02K 1/12

(52) U.S. Cl. 310/184; 310/68 B; 310/254; 310/180

(57) ABSTRACT

The present invention refers to an electronically commutated single phase motor comprising a rotor (2; 202; 302) and a stator (3; 203; 303) with an asymmetrical wound yoke (4; 204; 304) and comprising at least a stator phase (5; 205; 305) energized via an electronic commutation circuit in accordance with a driving signal generated by sensor means (8; 208; 308) for detecting the angular position of said rotor (2; 202; 302); said sensor means (8; 208; 308) comprise at least an inductive coil (9; 209; 219; 309) that is coupled magnetically to said rotor (2; 202; 302) and is arranged at substantially 90 electrical degrees with respect to said stator phase (5; 205; 305); the inductive coil (9; 209; 219; 309) and the stator phase (5; 205; 305) are arranged adjacent to each other and are wound round axes that are substantially parallel to each other.

The present invention refers to an electronically commutated single-phase motor comprising a rotor, a stator with asymmetric wound yoke, and sensor means to detect the angular position of the rotor.

The Italian patent no. 1268400, granted on 27^{th} Feb. 1997 to this same Applicant following an application filed on 30^{th} Mar. 1994, which shall be intended as being incorporated herein by reference in its entirety, describes an electronically commutated motor comprising a ferromagnetic or permanent-magnet rotor and a wound stator comprising at least a stator phase that is energized via an electronic-commutation circuit in accordance with a driving signal generated by sensor means detecting the angular position of the rotor. These sensor means comprise an inductive coil that is magnetically coupled with the rotor and arranged at 90 electrical degrees with respect to the stator phase, so that the driving signal is induced in the sensor with a corresponding phase shift with respect to the voltage induced in the stator phase.

Although the above-described technical solution has been found to be particularly advantageous, it nevertheless may involve significant complications from an industrial engineering point of view, in particular as far as the sensor means are concerned, in view a mass production of the motors in which it is implemented.

The application of the sensor means described in the afore-cited patent publication to a single-phase motor provided with an asymmetrical, e.g. U-shaped stator yoke implies further construction-related and operation-related complications: the sensor means would in fact be positioned in the most advantageous manner quite close to the rotor, but far enough from the coils of the main winding in order to avoid the electromagnetic flux generated by these coils; however, such a positioning of the sensor means implies that the terminals connecting the coils and the sensor means to the electronic circuit-board be placed at a distance from each other thereby causing them to be quite difficult and inconvenient to be connected to said electronic circuit-board.

In this application, the need furthermore arises for the arrangement of the sensor means at 90 electrical degrees with respect to the electromagnetic flux generated by the coils of the main winding to be strictly ensured in view of enabling a correct detection of the angular position of the rotor to be obtained: an arrangement of the sensor means on the stator yoke close to or at the top portion of the flanks of the “U”, which would actually prove as the ideal arrangement for said sensor means, since they would be lying close to the rotor and distant from the coils (the turns of which are wound about each one of the shanks of the “U”), is not sufficient by itself to reliably ensure a correct positioning thereof owing to possibly existing misalignments of the top portions of the same flanks.

It therefore is the object of the present invention to provide a solution for the construction of an electronically commutated single-phase motor with asymmetrical yoke, and comprising sensor means for the detection of the angular position of the rotor, which proves to be particularly advantageous as far as both the construction and the operation effectiveness of the same motor are concerned.

Within this general object, it is a purpose of the present invention to provide a motor of the above-indicated kind, in which the arrangement of the sensor means proves ideal in view of both a correct detection of the angular position of the rotor and a convenient connection of the terminals thereof to the electronic circuit board.

Another purpose of the present invention is to provide a motor of the above-indicated kind, in which the arrangement of the sensor means at 90 electrical degrees with respect to the electromagnetic flux generated by the coils of the main winding is effectively ensured in view of obtaining a correct detection of the angular position of the rotor.

Another purpose yet of the present invention is to provide a motor of the above-indicated kind, which does not require any substantial modification to be introduced in coiling machines in view of making them able to produce the inductive coils of both the main coils and the sensor means.

Finally, an equally important purpose of the present invention is to provide a motor of the above-indicated kind, which is capable of being produced competitively from a cost-related point of view, using readily available machines, tools and techniques.

According to the present invention, these aims and advantages, along with further ones that will emerge from the following description, are reached in an electronically commutated single-phase motor comprising a rotor, an asymmetrical stator yoke and sensor means for detecting the angular position of the rotor incorporating the features and characteristics as recited in the appended claim 1.

Features and advantages of the present invention will anyway be more readily understood from the description of some preferred, although not sole embodiments that is given below by way of non-limiting example with reference to the accompanying drawings, in which:

FIG. 1 is front view of a motor according to the present invention;

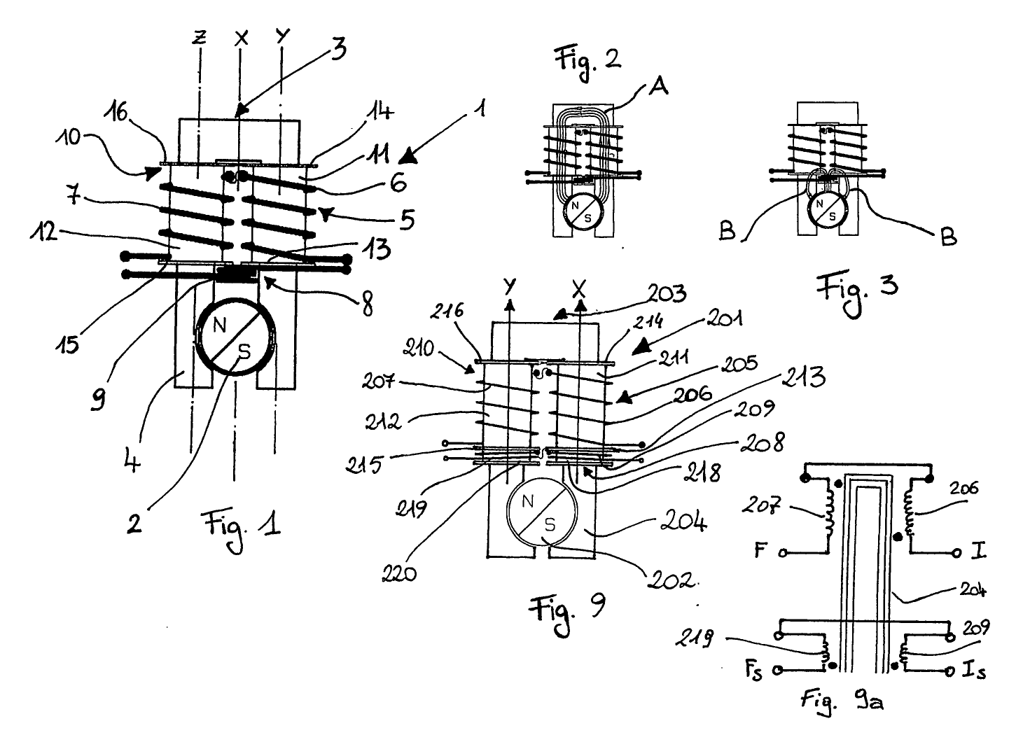

FIGS. 2 and 3 are front views showing schematically the directions of the fluxes generated by the stator yoke and the rotor, respectively, in the motor appearing in FIG. 1;

FIG. 4 is a perspective view of the bobbin for the main winding of the motor illustrated in the preceding Figures, in the initial configuration thereof after moulding;

FIG. 5 is a perspective view of the bobbin shown in FIG. 4, in the intermediate configuration that is takes during coiling of the sensor means;

FIG. 6 is a perspective view of the bobbin shown in FIG. 4, in the final configuration taken by it during coiling of the sensor means;

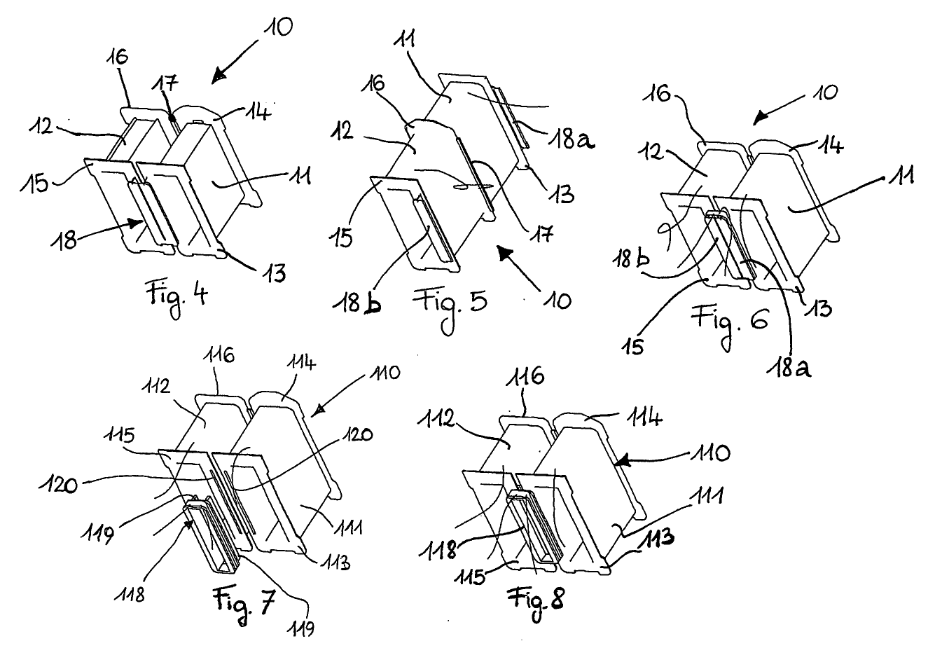

FIGS. 7 and 8 are perspective views of a different embodiment of the bobbin, in an intermediate configuration and a final configuration thereof, respectively;

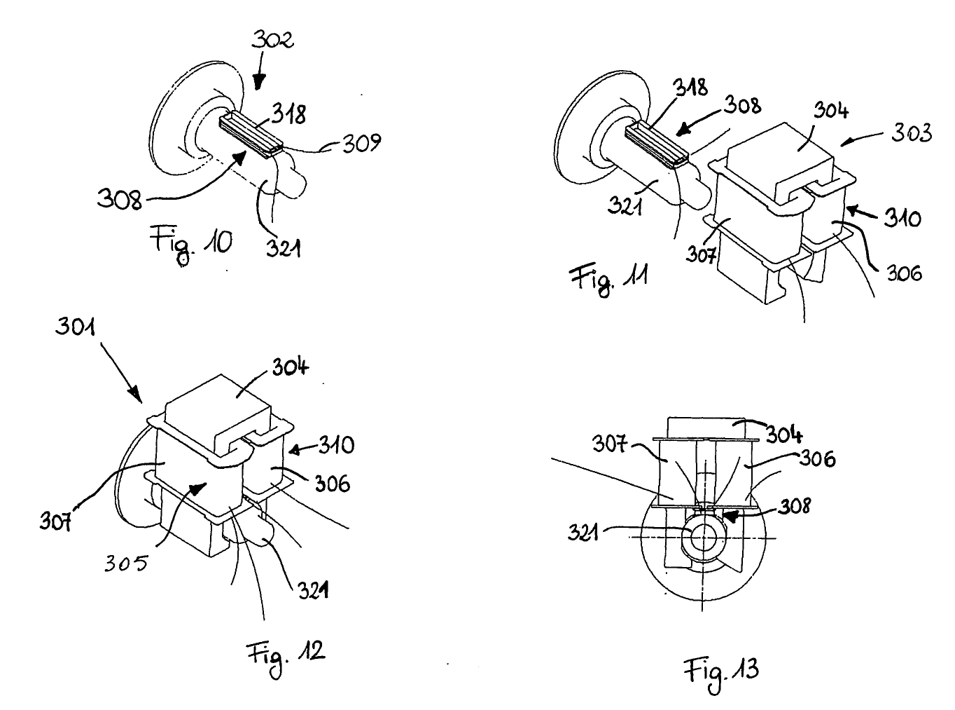

FIG. 9 is a front view of a second embodiment of the motor according to the present invention;

FIG. 9a is a schematical view of the coiling direction of the main winding and the coil of the sensor, respectively, of the second embodiment shown in FIG. 9;

FIGS. 10 through to 12 are perspective views of a third embodiment of the motor according to the present invention;

FIG. 13 is a front view of the motor shown in the preceding Figures.

With reference to the above-noted Figures, the reference numeral 1 is generally used there to indicate an electronically commutated single-phase motor, which comprises a rotor 2 and a stator 3 with an asymmetrical yoke 4 in the shape of substantially a U and comprising at least a stator phase 5, which in the example of embodiment illustrated in FIG. 1 is comprised of two main inductive windings 6 and 7 and is energized via an electronic commutation circuit in accordance with a driving signal generated by sensor means 8 detecting the angular position of the rotor 2.

Said sensor means 8 comprise an inductive coil 9 that is coupled magnetically to the rotor 2 and is arranged at an angle of substantially 90 electrical degrees with respect to the stator phase 5.

According to an innovatory feature of the present invention, the inductive coil 9 is arranged adjacent to the stator phase 5 and, therefore, to the main inductive windings 6, 7, and is wound round an axis X that is substantially parallel to the axes Y and Z, about which said main inductive windings 6 and 7 are wound.

In order to obtain said arrangement at 90 electrical degrees through the above-indicated configuration, the main windings 6 and 7 coiled round the two shanks of the U formed by the stator yoke 4 have mutually opposed directions, in such a manner as to generate a magnetic field with an orientation of the flux A as indicated in FIG. 2, whereas the coil 9 of the sensor means 8, which is placed between the two main windings 6 and 7, is wound in a single direction so that its flux can link with the leakage fluxes B generated by the magnet of the rotor 2, as this is shown schematically in FIG. 3.

Through the above-indicated arrangement, the magnetic field generated by the main windings 6, 7 does not link with the coil 9, whereas the magnetic field generated by the magnet of the rotor 2 is able to link with the coil 9, which therefore operates as if it were a coil arranged at 90 electrical degrees with respect to the main windings.

To act as a support for both the main windings 6 and 7 and the coil 9 of the sensor means 8 (hereinafter referred to simply and shortly as “sensor 8”) there is provided a bobbin 10 adapted to be associated to the stator yoke 4.

With reference to FIGS. 4 through to 6, the bobbin 10 comprises a first and a second support member 11, 12 for the main inductive windings 6, 7, said support members having a first pair of headpieces 13, 14 and a second pair of headpieces 15, 16, respectively, at the extremities thereof; the headpieces 13 and 15 and the headpieces 14 and 17 are arranged side-by-side and substantially co-planar with respect to each other.

To complete the bobbin 10 there is further provided a third support member 18 for the coil 9 of the sensor 8, which is associated, or is capable of being associated, to the respective headpieces 13 and 15 of the first and second support members 11, 12.

In an advantageous manner, the bobbin 10 is formed as a moulded part of a thermoplastic material in the initial configuration illustrated in FIG. 4, in which the first and second support members 11, 12 are facing each other and connected to each other at the respective headpieces 14 and 16 thereof via an elastically bendable connection member 17, whereas the headpieces 13 and 15 on the opposite side are separate from each other.

In the particular embodiment illustrated in FIGS. 4 to 6, the third support member 18 is comprised of at least two profile sections 18a, 18b having, at least along two separate and distinct lengths thereof, a preferably T-shaped cross-section, in which the shank of the T forms the support for the coil, whereas the beam or cross-bar of the T is the headpiece. The profile sections 18a, 18b are associated to the headpiece 13 and the headpiece 15, respectively, and are made integral, i.e. as a single-piece construction with the bobbin 10 during the moulding operation. The mutually facing surfaces of the cross-bars of the T's are advantageously in abutting contact with each other so as to provide greater stability to the bobbin 10, as well as to ensure the correct positioning of the sensor 8 at 90 electrical degrees with respect to the stator phase 5.

From the initial configuration thereof shown in FIG. 4, the bobbin 10 is opened through the rotation of the first and second support members 11, 12 about the elastic hinge formed by the connection member 17, until the headpiece 16 comes into contact with the headpiece 14. The bobbin 10 comes in this way to take an intermediate configuration, which is best illustrated in FIG. 5 and is particularly adapted to allow for the coiling of the main windings 6, 7 to be carried out simultaneously. As soon as this coiling operation is concluded, the bobbin 10 is closed again through the rotation of said support members in the opposite direction with respect to the previous one, until it comes to take the final configuration illustrated in FIG. 6. The coil 9 of the sensor 8 is at this point wound round the third support member 18. Upon completion of this operation, the same coil 9 cooperates to keep the bobbin 10 closed.

FIGS. 7 and 8 illustrate a different embodiment of the bobbin, in which the third support member 118 is obtained separately from the first support member 111 and the second support member 112; once the main windings have been coiled in the above-described manner, the third support member 118 is connected to the bobbin 110 at the headpieces 113 and 115 thereof, with the aid of connection means known as such in the art, such as for instance by snap-fitting appropriate links 119 belonging to the third support member 118 into slits 120 provided in the headpieces 113, 115, or with the use of suitable bonding, welding, riveting or similar techniques known as such in the art.

Fully apparent from the above description is therefore the ability of the the present invention to effectively reach the afore cited aims and advantages by actually providing a solution for the construction of an electronically commutated single-phase motor, in which the arrangement of the sensor means 8 is the optimum one as far as both the correct detection of the angular position of the rotor 2 and the connection of the terminals of the windings 6, 7, 9 to the electronic circuit-board (not shown) are concerned. In fact, thanks to the particular arrangement of the respective windings, the magnetic field generated by the stator phase 5 does not interfere with the sensor 8, whose coil 9 is solely linked with the magnetic field generated by the rotor 2; the mutually adjacent arrangement of the stator phase 5 and the sensor 8 does therefore not affect the correct detection of the angular position of the rotor 2, while at the same time allowing for the arrangement of the windings in such a manner as to enable the terminals thereof to lie close to each other in view of a convenient connection thereof to the electronic circuit-board.

In addition, the positioning of the sensor means at 90 electrical degrees with respect to the electromagnetic flux generated by the coils of the main winding is ensured also physically, thanks to the third support member 18, 118 being so provided as to rest directly on both the first and the second support members 11, 12, 111, 112: such a contrivance is effective in considerably reducing the possibility for misalignments to occur between the main winding and the sensor coil.

The motor according to the present invention proves furthermore particularly advantageous from a manufacturing point of view: winding and coiling operations can in fact be performed in an extremely convenient and quick manner without any need arising for conventional winding machines to be modified to any substantial extent, thanks to the conformation of the bobbin 10, 110 adapted to support both the main winding and the sensor coil.

It will of course be appreciated that the present invention, as described above, may be subject to a number of modifications or may be embodied in a number of different manners without departing from the scope of the invention.

So, for instance, FIG. 9 can be notices to illustrate a second embodiment of the present invention, in which the reference numeral 201 is generally used there to indicate an electronically commutated single-phase motor, which comprises a rotor 202 and a stator 203 with an asymmetrical yoke 204 in the shape of substantially a U and comprising at least a stator phase 205, which is comprised of a first and a second main inductive windings 206 and 207 and is energized via an electronic commutation circuit in accordance with a driving signal generated by sensor means 208 detecting the angular position of the rotor 202.

Said sensor means 208 comprise a third and a fourth inductive coils 209, 219 that are coupled magnetically to the rotor 202 and are arranged at an angle of substantially 90 electrical degrees with respect to the stator phase 205.

Said third and fourth inductive coils 209, 219 are arranged adjacent to the stator phase 205 and, therefore, to the main inductive windings 206, 207, and are wound round axes that are substantially coinciding with the axis X of the first winding 206 and the axis Y of the second winding 207, respectively, which are arranged substantially parallel to each other.

In order to obtain said arrangement at 90 electrical degrees through the above-indicated configuration, the main windings 206 and 207 wound round the two shanks of the U formed by the stator yoke 204 are magnetically concordant with respect to the stator yoke 204 and the main magnetic flux, whereas the coils 209, 219 of the sensor means 208 are magnetically discordant with respect to said same stator yoke 204 and main magnetic flux, so that their fluxes can link with the leakage fluxes generated by the magnet of the rotor 202.

Represented schematically in FIG. 9a are the arrangements of the main windings 206, 207 and the coils 209, 219 of the sensor 208 relative to the stator yoke 204; the reference letters I and F are used to indicate the beginning and the end of the main windings 206, 217, whereas the reference letters Is and Fs are used to indicate the beginning and the end of the coils 209, 219.

With the above-indicated arrangement, the magnetic field generated by the main windings 206, 207 nullifies on the coils 209, 219 of the sensor means 208, whereas the magnetic field generated by the magnet of the rotor 202 sums up on said coils 209, 219, which therefore act as if they were a single coil arranged at 90 electrical degrees with respect to the main windings.

To act as a support for said windings and coils 206, 207, 209, 219 there is provided a bobbin 210 adapted to be associated to the stator yoke 204, and comprising a first and a second support member 211, 212 for the main inductive windings 206, 207, as well as a third and a fourth support member 218, 220 for the coils 209, 219 of the sensor means 208, which are separated from each other by respective headpieces 213, 214, respectively. As far as the aspects connected with the production of this bobbin 210 are concerned, as well as the manner in which it works, reference should be made to the related description given afore in connection with the bobbins 10, 110.

FIGS. 10 to 13 illustrate a third embodiment of the motor according to the present invention, in which the third support member 318 for the inductive coil 309 of the sensor means 308 is associated to a casing 321 for the rotor 302, instead of being associated to the bobbin 310 as in the previously described embodiments. The third support member 318 may be connected to the casing 321 by any of a number of known connection means or may be obtained integrally, i.e. as a single-piece construction, with the same casing 321.

Once the coiling operation of the main windings 306 and 307 is completed in the afore-described manner, and once the coil 309 of the sensor means 308 has been wound round the third support, member 318, the casing 321 with the coil 309 associated thereto is introduced in the stator yoke 304, so as illustrated in FIG. 11, thereby obtaining the arrangement shown in FIGS. 12 and 13.

It should be noticed that the materials used, as well as the shapes and the sizing of the individual items of the motor of the invention, may each time be selected so as to more appropriately meet the particular requirements or suit the particular application.

1. Electronically commutated single-phase motor comprising a rotor (2; 202; 302) and a stator (3; 203; 303) with an asymmetrical wound yoke (4; 204; 304) and comprising at least a stator phase (5; 205; 305) energized via an electronic commutation circuit in accordance with a driving signal generated by sensor means (8; 208; 308) for detecting the angular position of said rotor (2; 202; 302), said sensor means (8; 208; 308) comprising at least an inductive coil (9; 209; 219; 309) that is coupled magnetically to said rotor (2; 202; 302) and is arranged at substantially 90 electrical degrees with respect to said stator phase (5; 205; 305), characterized in that said at least an inductive coil (9; 209; 219; 309) and said stator phase (5; 205; 305) are arranged adjacent to each other and are wound round axes that are substantially parallel to each other.

2. Motor according to claim 1, in which said stator yoke (4; 204; 304) has two arms round which there is wound said stator phase (5; 205; 305) comprising two main windings (6, 7; 206, 207; 306, 307).

3. Motor according to claim 2, in which said main windings (6, 7; 306, 307) and said coil (9; 309) of said sensor means (8; 308) are wound in a manner that said coil (9; 309) links with the magnetic field generated by said rotor (2; 302) and does not link with the magnetic field generated by said main windings (6, 7; 306, 307).

4. Motor according to claim 2, in which said main windings (6, 7; 206, 207; 306, 307) and said coil (9; 209; 219; 309) of said sensor means (8; 208; 308) are supported by a bobbin (10; 110; 210; 310) adapted to be associated to said stator yoke (4; 204; 304).

5. Motor according to claim 4, in which said bobbin (10; 110; 210; 310) is comprised of a first and a second support member (11, 12; 111, 112; 211, 212) for said main inductive windings (6, 7; 206, 207; 306, 307), said support members having a first pair of headpieces (13, 14; 113, 114; 213, 214) and a second pair of headpieces (15, 16; 115, 116; 215, 216), respectively, at the extremities thereof, said respective pairs of headpieces being arranged side-by-side and substantially co-planar with respect to each other.

6. Motor according to claim 5, in which said bobbin (10) is further provided with a third support member (18; 218, 220) for said coil (9; 209; 219) of said sensor means (8; 208), which is associated, or is capable of being associated, to the respective headpieces (13, 15; 113, 115; 213, 215) of said first and said second support members (11, 12; 111, 112; 211, 212).

7. Motor according to claim 6, in which said third support member (18; 118, 218, 220) is obtained integrally with said bobbin (10; 210).

8. Motor according to claim 6, in which said third support member (118) is connected to said bobbin (110).

9. Motor according to claim 1, in which said sensor means (208) comprise a third and a fourth inductive coils (209, 219) that are coupled magnetically to said rotor (202) and are arranged at substantially 90 electrical degrees with respect to said stator phase (205).

10. Motor according to claim 9, in which said third and fourth inductive coils (209, 219) are arranged adjacent to said stator phase (205) and, therefore, to said main inductive windings (206, 207), and are wound round respective axes that are substantially coinciding with the axis (X) of said first winding (206) and the axis (Y) of said second winding (207), respectively, said axes (X, Y) being substantially parallel to each other.

11. Motor according to claim 10, in which said main inductive windings (206, 207) and said third and fourth inductive coils (209, 219) of said sensor means (208) are wound in a manner that they are magnetically concordant and magnetically discordant, respectively, with respect to said stator yoke (204) and the main magnetic flux.

12. Motor according to claim 11, in which said bobbin is provided with a third and a fourth support member (218, 220) for said third and forth coils (209, 219), respectively, of said sensor means (208), which are separated from each other by respective headpieces (213, 214).

13. Motor according to claim 1, in which said third support member (318) for said inductive coil (309) of said sensor means (308) is associated to a casing (321) for said rotor (302).

14. Motor according to claim 13, in which said third support member (318) is connected to said casing (321) by any of a number of known connection means

15. Motor according to claim 13, in which said third support member (318) is formed integrally with said casing (321).

16. Motor according to claim 13, in which said casing (321), with said coil (309) associated thereto, is introduced in said stator yoke (304) fitted with said main windings (306, 307).

17. Motor according to claim 2, in which said sensor means (208) comprise a third and a fourth inductive coils (209, 219) that are coupled magnetically to said rotor (202) and are arranged at substantially 90 electrical degrees with respect to said stator phase (205).

18. Motor according to claim 3, in which said sensor means (208) comprise a third and a fourth inductive coils (209, 219) that are coupled magnetically to said rotor (202) and are arranged at substantially 90 electrical degrees with respect to said stator phase (205).

19. Motor according to claim 4, in which said sensor means (208) comprise a third and a fourth inductive coils (209, 219) that are coupled magnetically to said rotor (202) and are arranged at substantially 90 electrical degrees with respect to said stator phase (205).

20. Motor according to claim 5, in which said sensor means (208) comprise a third and a fourth inductive coils (209, 219) that are coupled magnetically to said rotor (202) and are arranged at substantially 90 electrical degrees with respect to said stator phase (205).
